(19) United States
(12) Patent Application Publication
(10) Pub. No.: US 2008/0159767 A1
(43) Pub. Date: Jul. 3, 2008

(54) Image forming apparatus and an accounting method therein

(76) Inventor: Masanori Tanaka, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/044,562

(22) Filed: Jan. 28, 2005

(30) Foreign Application Priority Data
Jan. 30, 2004 (JP) 2004-023466

(51) Int. Cl. G03G 21/02

(52) U.S. Cl. 399/79

(57) ABSTRACT

An image forming apparatus (10) for forming an image on a recording medium (30) such as a recording paper by applying ink is disclosed. The apparatus includes an ink discharging unit (20) that applies ink onto the recording medium to form the image; a sensor (6) that detects that a predetermined event has happened; and an accounting unit (2) that performs an account process at a predetermined adequate time based on the detection by the sensor.

### BACKGROUND OF THE INVENTION

1. Field of the Invention

The present invention relates to an image forming apparatus and an accounting method in the image forming apparatus.

2. Description of the Related Art

In image forming apparatuses such as copying machines in offices, fees are charged in accordance with an amount of use of the apparatus (for example, the number of ejected papers or the number of used recording papers), which is relating to maintenance. In copying machines or facsimile machines placed at shops like convenience stores, fees are charged to customers depending on the sizes and the numbers of recording papers (or originals) used or sent by the customers. In image forming apparatuses utilizing electro photographic technology, fees are charged dependent on, generally, sizes and the numbers of printed and output papers. Accounting is done per page, after fixing toner image transferred onto a recording paper and ejecting the paper.

Some image forming apparatuses have two modes, a normal mode and saving mode. In such apparatuses, accounting is done depending on an amount of recording agent (for example, toner) used in printing, after selecting a mode, as described in Japanese Patent Laid-open Application No. 11-272350. In the saving mode (using less recording agent), the printed image is light and the recording agent is not enough to show a clear image.

However, in image forming apparatuses like an inkjet printer, toner fixing is not done, and a clear image can be obtained even during image forming (for example, only a part of a recording paper is printed and printing operation is stopped on the way). The amount of used recording agent is not necessarily proportional to the amount of apparatus operation, due to variations of recording paper conveyance, printing head moving and other factors. And therefore, the amount of used recording agent is not adequate as a basis for charging fees in prior accounting methods, which are related to maintenance. That the amount of used recording agent is not adequate is significant in an image forming apparatus having a large printing head capable of forming an image on a large area at once.

### SUMMARY OF THE INVENTION

Accordingly, it is a general object of the present invention to provide an image forming apparatus (such as inkjet printers, thermal type or sublimating type printers) and an accounting method therein, in which accounting can be performed precisely dependent on the amount of the use of the apparatus, which is related to its maintenance.

Features and advantages of the present invention are set forth in the description that follows, and in part will become apparent from the description and the accompanying drawings, or may be learned by practice of the invention according to the teachings provided in the description. Objects as well as other features and advantages of the present invention will be realized and attained by an image forming apparatus and accounting method therein particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides as follows.

According to one feature of the present invention, there is provided an image forming apparatus for forming an image on a recording medium such as a recording paper by applying ink, comprising:
an ink discharging unit that applies ink onto the recording medium to form the image;
a sensor that detects that a predetermined event has happened; and
an accounting unit that performs an account process at a predetermined adequate time based on the detection by the sensor.

In the above described image forming apparatus, the accounting unit may perform the account process when the sensor detects that a rear end of the recording medium has passed the ink discharging unit.

In the above described image forming apparatus, the accounting unit may perform the account process when the sensor detects that a front end of the recording medium has passed the ink discharging unit.

The above image forming apparatus may further comprise:
a switching unit (1) that selects as a predetermined adequate time for performing the account process, when detecting that a rear end of the recording medium has passed the ink discharging unit or when detecting that a front end of the recording medium has passed the ink discharging unit.

According to another feature of the present invention, there is provided an image forming apparatus for forming an image on a recording medium such as a recording paper by applying ink, comprising:
a calculator that calculates an operating parameter while forming an image on each page, based on printing data;
a counter that counts the actual operating parameter; and
an accounting unit that performs an accounting process according to a rate of the actual operating parameter to the calculated operating parameter.

In the above image forming apparatus, the operating parameter may be the number of operation cycles of a printing device of an ink discharging unit while forming image on each page.

In the image forming apparatus, the operating parameter may be the length of the recording medium passing an ink discharging unit while forming an image on each page.

According to another feature of the present invention, there is provided an image forming apparatus for forming an image on a recording medium such as a recording paper by applying ink, comprising:
ink discharging means for applying ink onto the recording medium to form the image;
sensing means for detecting that a predetermined event has happened; and
accounting means for performing an account process at a predetermined adequate time based on the detection by the sensing means.

In the image forming apparatus, the accounting means performs the account process when the sensing means detects that the rear end of the recording medium has passed the ink discharging means.

In the above image forming apparatus, the accounting means may perform the account process when the sensing means detects that the front end of the recording medium has passed the ink discharging means.

The above image forming apparatus may further comprise:
switching means for selecting as a predetermined adequate time for performing the account process, when detecting that the rear end of the recording medium has passed the ink discharging means or when detecting that the front end of the recording medium has passed the ink discharging means.

According to another feature of the present invention, there is provided an image forming apparatus for forming an image on a recording medium such as a recording paper by applying ink, comprising:
calculating means for calculating an operating parameter while forming an image on each page, based on printing data;
counting means for counting the actual operating parameter; and
accounting means for performing an accounting process according to a ratio of the actual operating parameter to the calculated operating parameter.

In the above image forming apparatus, the operating parameter may be the number of operation cycles of a printing device of ink discharging means while forming an image on each page.

According to another feature of the present invention, there is provided an image forming apparatus wherein the operating parameter may be the length of the recording medium passing ink discharging means while forming an image on each page.

According to another feature of the present invention, there is provided an accounting method in an image forming apparatus for forming an image on a recording medium such as a recording paper by applying ink, in which
an accounting process is performed when detecting that the rear end of the recording medium has passed an ink discharging unit.

According to another feature of the present invention, there is provided an accounting method in an image forming apparatus that forms an image on recording paper by applying ink, characterized in that
an accounting process is performed when detecting that the front end of the recording medium has passed an ink discharging unit.

According to another feature of the present invention, there is provided an accounting method in an image forming apparatus for forming an image on a recording medium such as a recording paper by applying ink, characterized in that
the accounting method can switch between an accounting process being performed when detecting that the rear end of the recording medium has passed an ink discharging unit and the accounting process being performed when detecting that the front end of the recording medium has passed the ink discharging unit.

According to another feature of the present invention, there is provided an accounting method in an image forming apparatus for forming an image on a recording medium such as a recording paper by applying ink, comprising:
calculating operation cycles of a printing device of an ink discharging unit while forming an image on each page, based on printing data;
counting actual operation cycles; and
performing an accounting process according to a ratio of the actual operation cycles to the calculated operation cycles.

According to another feature of the present invention, there is provided an accounting method in an image forming apparatus for forming an image on a recording medium such as a recording paper by applying ink, comprising calculating the length of the recording medium passing an ink discharging unit while forming an image on each page, based on printing data; counting the length of the recording medium that actually has passed the ink discharging unit; and performing an accounting process according to a ratio of the actual length to the calculated length of the recording medium.

### BRIEF DESCRIPTION OF THE DRAWINGS

FIG. 1 shows major blocks of an image forming apparatus according to an embodiment of the present invention;

FIG. 2 explains the operation of the image forming apparatus according to the embodiment of the present invention;

FIG. 3 is a flowchart illustrating an accounting procedure in the image forming apparatus according to a first example of the present invention;

FIG. 4 is a flowchart illustrating an accounting procedure in the image forming apparatus according to a second example of the present invention;

FIG. 5 is a flowchart illustrating an accounting procedure in the image forming apparatus according to a third example of the present invention;

FIG. 6 is a flowchart illustrating an accounting procedure in the image forming apparatus according to a fourth example of the present invention; and

FIG. 7 is a flowchart illustrating an accounting procedure in the image forming apparatus according to a fifth example of the present invention.

### DESCRIPTION OF THE PREFERRED EMBODIMENTS

In the following, embodiments of the present invention are described with reference to the accompanying drawings.

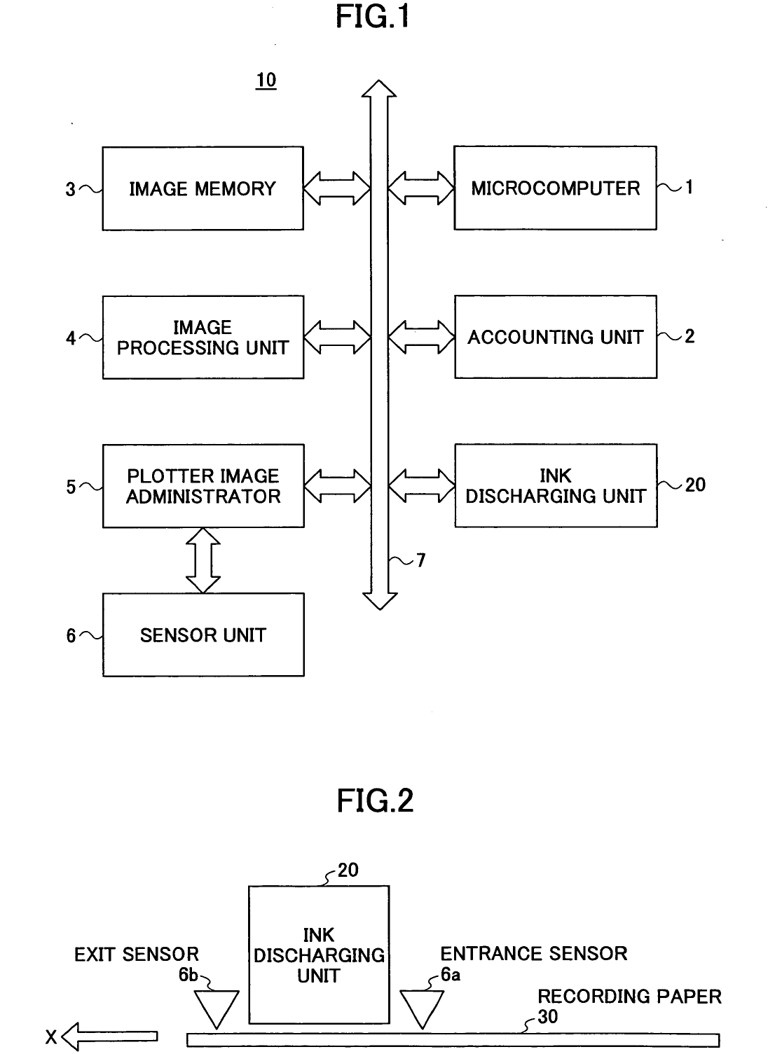

FIG. 1 generally shows major functional blocks of an image forming apparatus having an accounting function according to the present invention. The image forming apparatus 10 comprises a microcomputer 1, an accounting unit 2, an imaging memory 3, an image processing unit 4, a plotter image administrator 5, a sensor unit 6, a bus 7 and an ink discharging unit 20. The microcomputer 1 controls all the processing in the apparatus 10 and has a CPU, RAM, nonvolatile memory and others. The microcomputer 1 further comprises a counter for counting predetermined parameters, a memory for storing counted values, a switching function for performing selection among options regarding accounting methods, and a memory for storing the selected option.

The accounting unit 2 clearly shows accounting conditions to the outside (not shown). The microcomputer 1 can process accounting data, and allocate the accounting data processing power to the accounting unit 2. For example, the microcomputer can select a timing for accounting and report the accounting timing and an accounting amount to the accounting unit 2, which can indicate the accounting conditions or report them to outside devices (such as accounting and summing devices on an network).

The image memory 3 stores information with respect to an image of one page to be printed. When the printing is started, data are transferred from the image memory 3 to the image processing unit 4, where image processing suitable for printing is performed.

The image processing unit 4 receives the data sent from the image memory 3 and performs image processing on the data so as to make them suitable for printing. For example, in a printing mechanism having a head which moves along a major scanning direction and has embedded inkjet nozzles arranged along a sub scanning direction, the data stored in the image memory 3 should be rearranged so as to be properly sent to the nozzles. This rearranging processing is referred to as “rendering”. The image processing is in general carried out by an ASIC (Application Specific IC) or a microcomputer.

The plotter image administrator 5 administers the operation of the printing mechanism. The plotter image administrator 5 feeds recording papers required for image printing to the printing mechanism, detects the arrival of the fed recording papers by the sensor unit 6, and operates the printing mechanism and reports the printing conditions of the printing mechanism via the bus 7 to other devices in the image forming apparatus 10.

FIG. 2 explains the operation of the image forming apparatus 10 when it forms an image. When forming an image, a recording paper 30 is conveyed to a direction indicted by X from the right to the left as shown. In this example, while the recording paper 30 moves under the ink discharging unit 20, an image is formed on the recording paper 30. In this example, the ink discharging unit 20 does not move along the sub scanning direction (from the right to the left in FIG. 2), but does move along the major scanning direction (perpendicular to the plane of the paper of FIG. 2).

The nozzles of the ink discharging unit 20 inject or discharge ink while printing. An image is formed after the ink discharging. In a printing mechanism where the head moving along the major scanning direction has embedded inkjet nozzles aligned in the sub scanning direction, the printing mechanism scans to the major direction one time, which is enough to form an image on the recording paper.

Two sensors are provided one on each side of the ink discharging unit 20. When the recording paper 30 is conveyed, an entrance sensor 6a provided at the entrance of the ink discharging unit 20 and an exit sensor 6b provided at the exit of the ink discharging unit 20 can detect both ends of the recording paper 30. These sensors 6a and 6b do not move along the major scanning direction together with the ink discharging unit 20, but should be placed on the way where the recording paper 30 passes.

Next, some procedures of accounting methods in the image forming apparatus according to the present invention are explained below with reference to the drawings.

### FIRST EXAMPLE

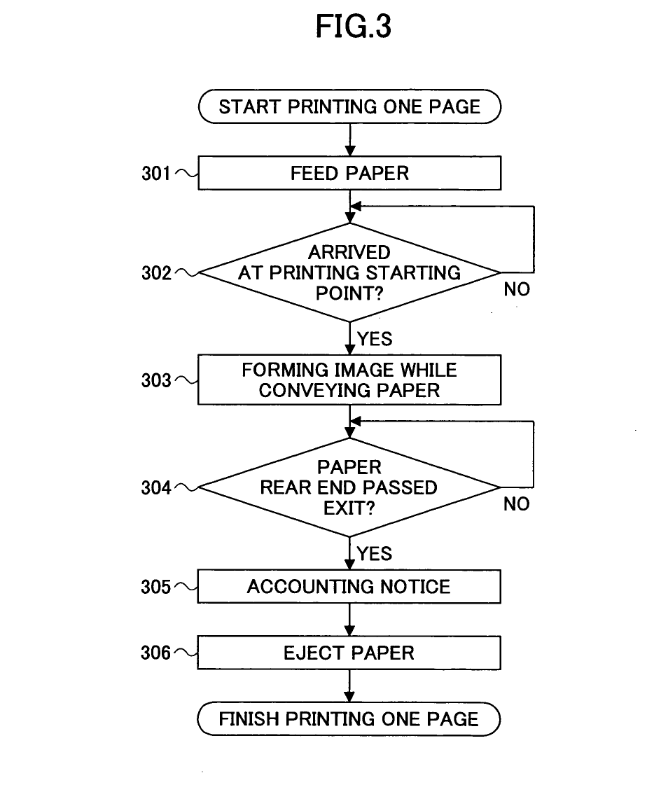

FIG. 3 is a flowchart illustrating an accounting procedure in the image forming apparatus according to a first example of the present invention. One recording paper 30 is taken out from a feeding tray (not shown) and conveyed along a conveying way to the ink discharging unit 20 at Step 301. When the front end of the recording paper 30 arrives at a predetermined printing starting point at Step 302, the image forming process starts. The printing starting point is normally provided in an image forming apparatus of printers or facsimile machines, in order to synchronize printing data reading and the image forming process. The image forming process is carried out while conveying the recording paper 30 at Step 303. At the exit of the ink discharging unit 20, a sensor 6b is provided to detect the existence of the recording paper 30. The sensor 6b is placed not at a paper ejecting point of the image forming apparatus, but at the exit of the ink discharging unit 20. When the sensor 6b detects that the rear end of the recording paper 30 has passed at Step 304, the microcomputer 1 gives an accounting notice to the accounting unit 2 at Step 305. Even after the image forming process is completed, the recording paper 30 is still conveyed and finally ejected to an ejecting tray (not shown) at Step 306. In a case where there is no accounting unit 2, a nonvolatile memory in the microcomputer 1 can store accounting contents. In a case where there is no sensor detecting the existence of the recording paper 30, after an ink discharging operation for forming an image on one page is completed, the microcomputer 1 can give an accounting notice to the accounting unit 2. In a case where there is no accounting unit 2, the nonvolatile memory in the microcomputer 1 can store the accounting contents.

In this manner, the end of the image forming process for one page can be detected, and therefore even if the recording paper 30 is not ejected from the image forming apparatus, accounting is surely done after the image forming.

### SECOND EXAMPLE

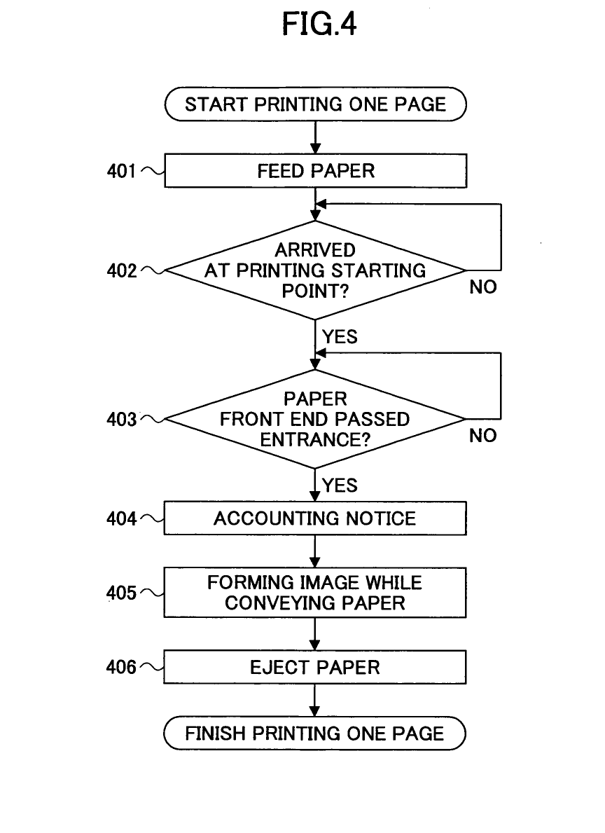

FIG. 4 is a flowchart illustrating an accounting procedure in the image forming apparatus according to a second example of the present invention. In the first example, the accounting is performed when the image formation is completed by detecting that the rear end of the recording paper 30 has passed the ink discharging unit 20. In this example, the accounting is performed when the image formation is started by detecting that the front end of the recording paper 30 has passed the ink discharging unit 20.

One recording paper 30 is taken out from a feeding tray (not shown) and conveyed along a conveying way to the ink discharging unit 20 at Step 401. When the front end of the recording paper 30 arrives at a predetermined printing starting point at Step 402, the image forming process starts. At an entrance of the ink discharging unit 20, an entrance sensor 6a is provided to detect the existence of the recording paper 30. When the entrance sensor 6a detects that the front end of the recording paper 30 has passed at Step 403, the microcomputer 1 gives an accounting notice to the accounting unit 2 at Step 404. After that the image forming process continues while conveying the recording paper 30 at Step 405. Even after the image forming process is completed, the recording paper 30 is still conveyed and finally ejected to an ejecting tray (not shown) at Step 406. The printing starting point is normally provided in an image forming apparatus of printers or facsimile machines, in order to synchronize printing data reading and the image forming process. However, the recording paper 30 does not necessarily pass the printing starting point before detection of the front end of the recording paper 30. Therefore, it may happen that the front end of the recording paper 30 is first detected, and then the recording paper 30 arrives at the printing starting point. In this case, Step 402 is carried out after the accounting notice at Step 404.

In a case where there is no accounting unit 2, the nonvolatile memory in the microcomputer 1 can store accounting contents. In a case where there is no sensor detecting the existence of the recording paper 30, when an ink discharging operation for forming an image on one page is started, the microcomputer 1 can give an accounting notice to the accounting unit 2. In a case where there is no accounting unit 2, the nonvolatile memory in the microcomputer 1 can store the accounting contents.

In this manner, the start of an image forming process for one page can be detected, and therefore accounting is surely done when starting the image forming.

### THIRD EXAMPLE

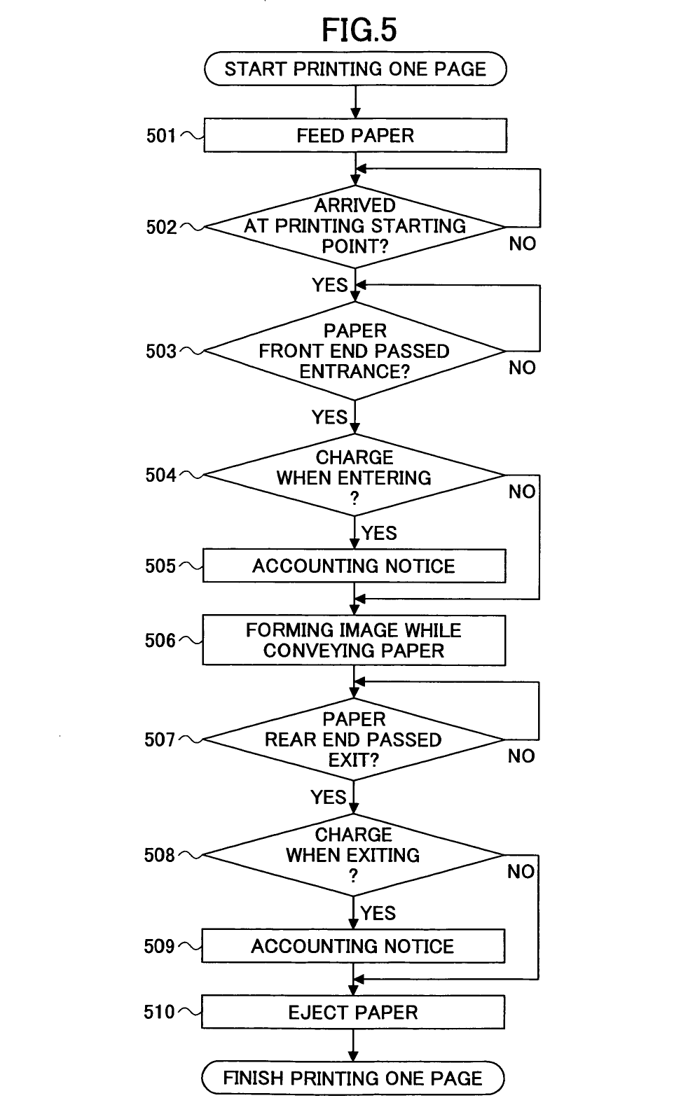

FIG. 5 is a flowchart illustrating an accounting procedure in the image forming apparatus according to a third example of the present invention. In this example, it can be switched between the accounting being performed when the rear end of the recording paper 30 has passed the ink discharging unit 20 and the accounting being performed when the front end of the recording paper 30 has passed the ink discharging unit 20.

In a case where the accounting unit 20 exists, the microcomputer 1 gives an accounting notice to the accounting unit 20 when the image formation is started (Steps 503, 504) or the image formation is completed (Steps 507, 508, 509) according to the switching condition stored in the microcomputer 2.

In a case where there is no accounting unit 2, the nonvolatile memory in the microcomputer 1 stores that the image formation has been started, and a first counter in the microcomputer increases its count value by one. And then the nonvolatile memory in the microcomputer 1 stores that the image formation has been completed, and a second counter in the microcomputer increases its count value by one. The accounting result is changed in accordance with the switching condition stored in the microcomputer 1. The first and second counters are normally equal to each other. If both the counter values exceed a threshold value, an abnormality may have occurred in the image forming apparatus, and the accounting may be improperly done. Under this situation, the accounting mode can be switched and it can be confirmed whether the accounting is properly done.

### FOURTH EXAMPLE

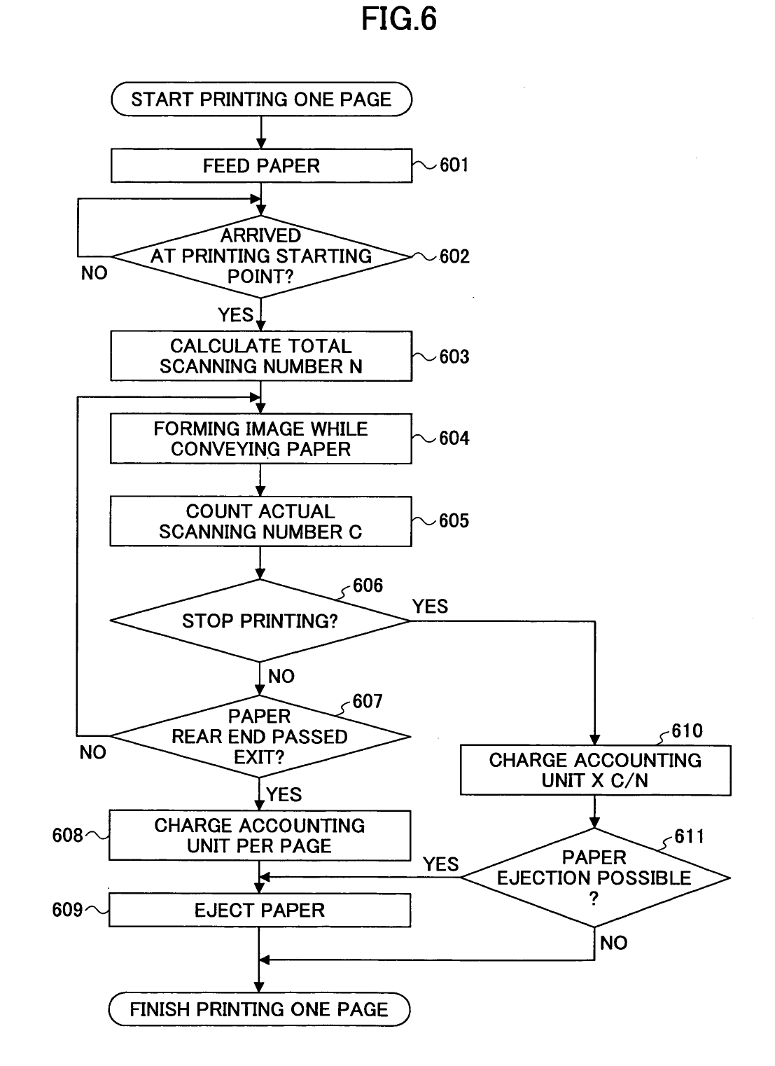

In a case where the ink discharging unit 20 comprises a head having arrayed nozzles, an image is formed by scanning the head over the recording paper 30. With reference to FIG. 6, the recording paper 30 arrives at the printing starting point at Step 602. The number N of total scanning passes required for forming a one-page image is calculated by analyzing the image data at Step 603. For this purpose, the microcomputer 1 may be a calculator. Each time when the head is scanned, a counter in the microcomputer increases its count value by one at Step 605. If an instruction is given to stop the image forming process during the printing of the page, after printing the page, the total scanning number N and the actual scanning number C are compared to each other. In a case where an accounting unit per one page is predetermined, the amount of the predetermined accounting unit multiplied by (the actual scanning number C)/(the total scanning number N) is charged at 610.

On the other hand, if the image forming is done without stopping until the end of the page and the rear end of the recording paper 30 is detected by the sensor 6b at Step 607, the predetermined accounting unit is fully charged.

In a case where an accounting unit per scan is predetermined, the predetermined accounting unit multiplied by the actual scanning number is charged. In this manner, even if the image forming is stopped during the course of printing a page, the exact accounting can be performed.

### FIFTH EXAMPLE

In the above fourth example, the accounting amount for one page is adjusted based on a head scanning rate. In this example, the accounting amount for one page is adjusted based on a recording paper conveying length.

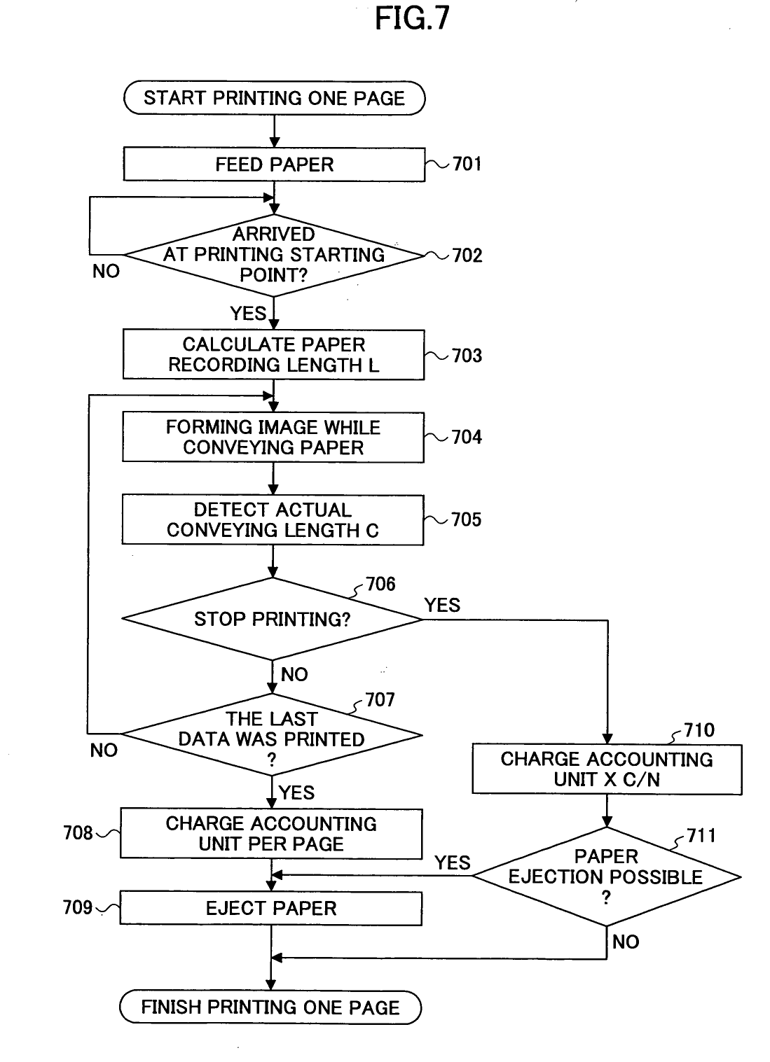

With reference to FIG. 7, the recording paper 30 arrives at the printing starting point at Step 702. A recording paper conveying length L is calculated by the microcomputer 1 by analyzing the image data at Step 703. When the image forming is started, the actual length C of conveyed recording paper 30 is detected at Step 705. This is equal to the detection of the actual printing length. If the printing is stopped before the last data are printed, the accounting unit per page multiplied by (the actual printed length C)/(calculated recording paper length L) is charged at Step 710. In this manner, even if the image forming is stopped during the course of printing a page, the exact accounting can be performed.

The present invention is not limited to these embodiments, but variations and modifications may be made without departing from the scope of the present invention.

The present application is based on Japanese Priority Application No. 2004-023466 filed on Jan. 30, 2004 with the Japanese Patent Office, the entire contents of which are hereby incorporated by reference.

What is claimed is:

1. An image forming apparatus for forming an image on a recording medium such as a recording paper by applying ink, comprising:
an ink discharging unit that applies ink onto the recording medium to form the image;
a sensor that detects that a predetermined event has happened; and
an accounting unit that performs an account process at a predetermined adequate time based on the detection by the sensor.

2. The image forming apparatus as claimed in claim 1, wherein the accounting unit performs the account process when the sensor detects that a rear end of the recording medium has passed the ink discharging unit.

3. The image forming apparatus as claimed in claim 1, wherein the accounting unit performs the account process when the sensor detects that a front end of the recording medium has passed the ink discharging unit.

4. The image forming apparatus as claimed in claim 1, further comprising:
a switching unit that selects as the predetermined adequate time for performing the account process, one of when detecting that a rear end of the recording medium has passed the ink discharging unit and when detecting that a front end of the recording medium has passed the ink discharging unit.

5. An image forming apparatus for forming an image on a recording medium such as a recording page by applying ink, comprising:
a calculator that calculates an operating parameter while forming an image on each page, based on printing data;
a counter that counts an actual operating parameter; and
an accounting unit that performs an accounting process according to a ratio of the actual operating parameter to the calculated operating parameter.

6. The image forming apparatus as claimed in claim 5, wherein the operating parameter is the number of operation cycles of a printing device of an ink discharging unit while forming an image on each page.

7. The image forming apparatus as claimed in claim 5, wherein the operating parameter is a length of the recording medium passing an ink discharging unit while forming an image on each page.

8. An image forming apparatus for forming an image on a recording medium such as a recording paper by applying ink, comprising:
ink discharging means for applying ink onto the recording medium to form the image;
sensing means for detecting that a predetermined event has happened; and
accounting means for performing an account process at a predetermined adequate time based on the detection by the sensing means.

9. The image forming apparatus as claimed in claim 8, wherein the accounting means performs the account process when the sensing means detects that a rear end of the recording medium has passed the ink discharging means.

10. The image forming apparatus as claimed in claim 8, wherein the accounting means performs the account process when the sensing means detects that a front end of the recording medium has passed the ink discharging means.

11. The image forming apparatus as claimed in claim 8, further comprising:
switching means for selecting as the predetermined adequate time for performing the account process, one of when detecting that a rear end of the recording medium has passed the ink discharging means and when detecting that a front end of the recording medium has passed the ink discharging means.

12. An image forming apparatus for forming an image on a recording medium such as a recording page by applying ink, comprising:
calculating means for calculating an operating parameter while forming an image on each page, based on printing data;
counting means for counting an actual operating parameter; and
accounting means for performing an accounting process according to a ratio of the actual operating parameter to the calculated operating parameter.

13. The image forming apparatus as claimed in claim 5, wherein the operating parameter is the number of operation cycles of a printing device of ink discharging means while forming an image on each page.

14. The image forming apparatus as claimed in claim 12, wherein the operating parameter is a length of the recording medium passing ink discharging means while forming an image on each page.

15. An accounting method in an image forming apparatus for forming an image on a recording medium such as a recording paper by applying ink, comprising a step of:
performing an accounting process when detecting that a rear end of the recording medium has passed an ink discharging unit.

16. An accounting method in an image forming apparatus for forming an image on a recording medium such as a recording paper by applying ink, comprising a step of:
performing an accounting process when detecting that a front end of the recording medium has passed an ink discharging unit.

17. An accounting method in an image forming apparatus for forming an image on a recording medium such as a recording paper by applying ink, comprising a step of:
switching the accounting method between an accounting process being performed when detecting that a rear end of the recording medium has passed an ink discharging unit and the accounting process being performed when detecting that a front end of the recording medium has passed the ink discharging unit.

18. An accounting method in an image forming apparatus for forming an image on a recording medium such as a recording paper by applying ink, comprising the steps of:
calculating operation cycles of a printing device of an ink discharging unit while forming an image on each page, based on printing data;
counting actual operation cycles; and
performing an accounting process according to a ratio of the actual operation cycles to the calculated operation cycles.

19. An accounting method in an image forming apparatus for forming an image on a recording medium such as a recording paper by applying ink, comprising the steps of:
calculating a length of the recording medium passing an ink discharging unit while forming an image on each page, based on printing data;
counting a length of the recording medium that actually has passed the ink discharging unit; and
performing an accounting process according to a ratio of the actual length to the calculated length of the recording medium.
